(19) United States
(12) Patent Application Publication
(10) Pub. No.: US 2006/0047046 A1
(43) Pub. Date: Mar. 2, 2006

(54) Thixotropic anaerobic adhesive

(75) Inventor: Hans E. Haas, Stow, OH (US)

Correspondence Address: GIFFORD, KRASS, GROH, SPRINKLE & CITKOWSKI, P.C, PO BOX 7021, TROY, MI, 48007-7021, US

(73) Assignee: ILLINOIS TOOL WORKS, INC., GLENVIEW, IL (US)

(21) Appl. No.: 11/214,098

(22) Filed: Aug. 29, 2005

Related U.S. Application Data
(60) Provisional application No. 60/605,656, filed on Aug. 30, 2004.

(51) Int. Cl. C08K 3/22

(52) U.S. Cl. 524/432

(57) ABSTRACT

An anaerobic adhesive composition includes a monomer curable upon exclusion of oxygen. A peroxy polymerization initiator is present within the composition. The composition has a thixotrope imparting a thixotropic viscosity ratio in an uncured state of 8.2:1 to 11:1 as measured at rotation rates of 0.5 and 10 revolutions per minute. The thixotrope is composed of 3 to 50 total weight percent of inorganic particulate or 3 to 36 total weight percent of an organic compound. A process for forming an adhesive bond includes applying to a fastener an anaerobic adhesive composition that includes a polymerizable acrylate ester or vinyl ether, a peroxy polymerization initiator, and a thixotrope. The composition has a thixotropic viscosity ratio of between 8.2:1 and 11:1 for spindle rotation rates of 0.5 and 10.0 revolutions per minute. Tightening the fastener against a substrate induces viscosity breakdown and under the force to cure.

### RELATED APPLICATION

This application claims priority of U.S. Provisional Patent Application Ser. No. 60/605,656 filed Aug. 30, 2004, which is incorporated herein by reference.

### FIELD OF THE INVENTION

The present invention in general relates to anaerobic adhesives, and in particular to an anaerobic adhesive that exhibits a lower viscosity under the forces associated with tightening a fastener against a substrate.

### BACKGROUND OF THE INVENTION

An anaerobic adhesive is a curable composition that begins to cure upon exclusion of oxygen. As a result of this property, anaerobic adhesives have met with considerable acceptance for the purpose of retaining fasteners, and in particular threaded fasteners, within a complementary threaded bore. Since the curable components of an anaerobic adhesive are monomers and/or oligomers, the applied compositions were originally low viscosity liquids. U.S. Pat. Nos. 2,895,950 and 3,041,322 are representative of liquid anaerobic adhesives. The need to apply an anaerobic adhesive as a liquid has proven to be a limitation in instances where substrate geometry and/or location precludes application of a liquid. In response to this limitation, the prior art recognizes the functionality of non-flowable adhesive compositions. U.S. Pat. Nos. 6,451,927 B1; 3,547,851; and 4,092,374 are exemplary of such compositions. While the inclusion of encapsulants and/or thickeners has resulted in non-flowable anaerobic adhesive compositions amenable to dispensing as a gel or paste, a thickened composition has diminished flow into minute spaces thereby diminishing the adhesive strength of the resulting cured interface. Thus, there exists a need for a thickened anaerobic adhesive that exhibits thixotropic viscosity diminishment under the forces associated with bonding.

### SUMMARY OF THE INVENTION

An anaerobic adhesive composition includes a polymerizable monomer curable upon exclusion of oxygen. A peroxy polymerization initiator is also present within the composition. The composition also includes a thixotrope imparting to the composition a thixotropic viscosity ratio in an uncured state of 8.2:1 to 11.1:1 as measured at rotation rates of 0.5 and 10 revolutions per minute. The thixotrope is composed of 3 to 50 total composition weight percent of inorganic particulate or 3 to 36 total weight percent of the composition of an organic compound.

A process for forming an aerobic adhesive bond includes applying to a fastener an anaerobic adhesive composition that includes a polymerizable acrylate ester or vinyl ether, a peroxy polymerization initiator and a thixotrope. The composition is applied as a gel having a thixotropic viscosity ratio of between 8.2:1 and 11:1 for spindle rotation rates of 0.5 and 10.0 revolutions per minute. Tightening the fastener against a substrate induces viscosity breakdown of the composition. The composition flows under the forces associated with tightening and cures upon allocation of sufficient time. Superior interfacial adhesion is noted compared to conventional non-flowable anaerobic adhesive forms.

### DETAILED DESCRIPTION OF THE PREFERRED EMBODIMENTS

The present invention has utility as an anaerobic adhesive composition. The present invention is based on the discovery of desirable performance when a composition has a specific ratio of thixotropic viscosities under low shear and high shear conditions. Anaerobic compositions satisfying the inventive criterion create a larger surface area interface relative to conventional thickened anaerobic adhesives. The inventive anaerobic adhesive composition cures in the presence of a peroxy- or perester-compound with the exclusion of oxygen and is particularly well suited as thread lock.

An anaerobic composition according to the present invention includes a polymerizable acrylate ester monomer and/or vinyl ether monomer. Preferably, at least two polymerizable moieties are present within a monomer and more preferably at the termini of a linear monomer backbone. Acrylate esters operative herein illustratively include alpha-substituted acrylate esters, specifically including methacrylate, ethacrylate, and chloroacrylate esters. Di- or polyacrylate esters are well suited to form cross-linked polymers having well established high strength adhesive properties. However, it is appreciated that monoacrylate esters are operative herein to form cross-linked polymers especially in instances where the monoacrylate ester also includes a reactive substituent amenable to cross-linking. Such cross-linkable substituents illustratively include hydroxyl, amino, and cyano groups. Exemplary monoacrylate esters containing a cross-linkable moiety illustratively include hydroxyethyl methacrylate, cyanoethyl acrylate, terbutylaminoethyl methacrylate, and glycidyl methacrylate.

One of the most preferable groups of polyacrylate esters which can be used in the adhesives disclosed herein is polyacrylate esters which have the following general formula: 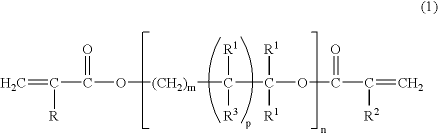
wherein R¹ represents a radical selected from the group consisting of hydrogen, lower alkyl of from 1 to about 4 carbon atoms, hydroxy alkyl of from 1 to about 4 carbon atoms, and the radical

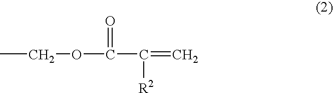

R² is a radical selected from the group consisting of hydrogen, halogen, and lower alkyl of from 1 to about 4 carbon atoms; R³ is a radical selected from the group consisting of hydrogen, hydroxyl, and 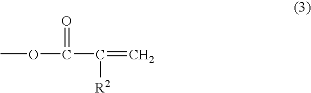
m is an integer equal to or greater than 1, and preferably from 1 to about 8 inclusive; n, is an integer equal to or greater than 1, and typically 20 or more: and p is either 0 or 1.

The polymerizable polyacrylate esters utilized in accordance with the invention and corresponding to the above general formula illustratively include di-, tri- and tetra-ethylene glycol dimethacrylate, dipropylene glycol dimethacrylate, polyethylene glycol dimethacrylate, di (pentamethylene glycol) dimethacrylate, tetraethylene glycol diacrylate, tetraethylene glycol di (chloroacrylate), diglycerol diacrylate, diglycerol tetramethacrylate, tetramethylene dimethacrylate, ethylene dimethacrylate, neopentyl glycol diacrylate and trimethylol propane triacrylate.

Yet another class of acrylate esters is those which are formed by the reaction of:
(a) an acrylate ester containing an active hydrogen atom in the alcoholic moiety of the ester; with
(b) an organic polyisocyanate.

Compositions including this general type of ester are disclosed in U.S. Pat. No. 3,425,988. Preferably, the active hydrogen is the hydrogen of a hydroxyl or a primary or secondary amine substituent on the alcoholic moiety of the ester, and the polyisocyanate is a diisocyanate. A stoichiometric excess of the acrylate ester is used to ensure that each isocyanate group in the polyisocyanate is substituted.

Typical polyisocyanates which can be reacted with the above acrylate esters to form polyacrylate monomers are toluene diisocyanate, 4,4′-diphenyl diisocyanate, di-anisidine diisocyanate, cyclohexylene diisocyanate, 2-chloropropane diisocyanate, 4,4′-diphenylmethane diisocyanate, 2,2′-diethyl ether diisocyanate, 3-(dimethylamino)-pentane diisocyanate, tetrachlorophenylene diisocyanate-1,4 and trans-vinylene diisocyanate. Still other polyisocyanates operative herein are higher molecular weight polyisocyanates obtained by reacting an excess of any of the above-described isocyanates with polyamines containing terminal, primary and secondary amine groups, or polyhydric alcohols, for example, the alkane and alkene polyols such as glycerol, 1,2,6-hexanetriol, 1,5pentanediol, ethylene glycol, polyethylene glycol, 4,4′-dihydroxydiphenyldimethylmethane and condensation products of alkylene oxides with 4,4′-dihydroxydiphenyldimethylmethane.

Other acceptable monomers operative herein are acrylate terminated epoxy or ester units such as reaction products of acrylic acid with hydroxy terminated ester or epoxy compounds, or low polymers thereof. It is appreciated that other anaerobically curing monomers, with their respective initiators, accelerators and inhibitors, are formulated according to the instant invention into a pressure sensitive anaerobic adhesive are operative herein. It is further appreciated that any of the above-described acrylate and polyacrylate ester monomers are optionally operative.

The presently preferred anaerobic monomers are triethyleneglycol dimethacrylate; the reaction product of hydroxypropyl methacrylate with methylene-bis-phenyl-4,4′-diisocyanate a polymer formed by methacrylate capping of a 1:1 adduct of toluene diisocyanate and hydrogenated 2,2-bis (4-hydroxyphenyl) propane as well as mixtures thereof.

There may also be present reactive monomers such as acrylic acid, methacrylic acid and the like which will cross-link with anaerobic monomers.

A vinyl ether monomer operative herein preferably includes at least polymerizable moieties. A vinyl ether monomer illustratively includes 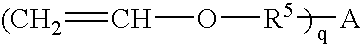
where R⁵ is a nullity, CH₂, C₆H₄, CH¹═CR³, and C≡C, where q is an integer of greater than or equal to one, where A is a nullity or a backbone moiety that is unreactive under free radical polymerization conditions. Additionally, ketone acetals are appreciated to be operative herein. Preferably, the ketone acetals include at least two such moieties per monomer. Specific examples of vinyl ethers operative herein include alleyl vinyl ether, divinyl ether butane diol-1,4 vinyl ether, ethylene glycol divinyl ether, diethylene glycol divinyl ether, triethylene glycol divinyl ether, tetraethylene glycol divinyl ether, hexanediol divinyl ether, cyclohexane diol divinyl ether and polytetrahydrofuryl divinyl ether. It is appreciated that a vinyl ether monomer is operative alone or as a coreactant with an acrylate ester.

A peroxy polymerization initiator is present to induce free radical polymerization of the acrylate ester monomer. Typical of the peroxy compounds operative as initiators are the hydroperoxides, preferably organic hydroperoxides of the formula R⁶OOH, wherein R⁶ is generally a hydrocarbon radical containing up to about 18 carbon atoms, preferably an alkyl, aryl or aralkyl radical containing from 1 to about 12 carbon atoms. Typical examples are cumene hydroperoxide, methyl ethyl ketone hydroperoxide and the like.

Accelerators operative herein include liquid and solid organo-nitrogen compounds illustratively including organic amides such as formamide, succinimide and the like; tertiary amines such as tributylamine, triethylamine, hexamethyl pararosaniline and the like; aromatic tertiary amines such as dimethyl paratoluidene and the like; organic sulfimides such as benzoyl sulfimide and the like; as well as mixtures thereof.

Depending upon the amount of anaerobic resin system contained in the polymer system, the amount of initiator plus accelerator added typically ranges from 0.5 to 20 percent by weight based on the total weight of the composition.

An inorganic particulate is preferably added as a thixotrope. Inorganic particulates operative herein as thixotropes illustratively include silica, fumed silica, diatomaceous earth, bentonite clay, alumina, titania, metal oxide nanocrystals, metal sulfide nanocrystals, inorganic nanotubes, high surface area graphite, turbostratic carbon, and boric acid. Inorganic particulate is effective as a thixotrope from about 3 to 50 total weight percent. It is appreciated that the amount of inorganic particulate necessary to operate as a thixotrope depends on variables such as particulate surface area, ionic bilayer characteristics, edge-free charge apportionment, and stability of the solvation spheres about particulate. Additionally, it is appreciated that modification of inorganic particulate surfaces with organic salts enhances the ability of inorganic particulate to form Van der Waal bonds and enhance this purported source of thixotropic properties. Inorganic particulate surface passivation with quaternary ammonium salts such as tetra C₂-C₂₄ ammonium halides serves to enhance interparticle interactions and therefore thixotropic properties. While quaternary ammonium salt derivatized bentonite organo clays are commercially available as thixotropes from a variety of manufacturers such as Süd-Chemie (Louisville, Ky.), other inorganic particulate is readily derivatized with quaternary ammonium salts through suspension in a solvent containing the quaternary ammonium salt. Through the use of C₄ or longer alkyl group containing salts, inorganic particulate according to the present invention is readily modified from a hydrophobic to a lipophilic material. Phase transfer of inorganic particulate between organic and aqueous solvents through quaternary ammonium salts is known to the art. H. Yao et al., Chem. Mater. 2001, 13, 4692-4697. Inorganic particulate is readily modified with C₁-C₂₄ ammoniums, a C₂-C₂₄ thiolates, and a C₈-C₂₄ alkyl or aryl alkoniums. While inorganic particulate having an organic salt derivatized surface is readily added to a precured anaerobic adhesive system that is conventional to the art to form a thixotropic composition, it is appreciated that such a salt is readily dissolved in a polymerizable monomer of the present invention and unmodified inorganic particulate mixed therewith so as to form the organic salt modification to organic particulate in situ. The relative amount of organic salt needed to passivate the surface of inorganic particulate is readily determined from a surface area projection of the organic salt through the bonding moiety. By way of example, tetra-alkyl ammonium has a surface area projection for coverage of typically between 5 and 20 square nanometers while fatty acid alkonium has a surface coverage typically of from 4 to 16 square nanometers, and C₂-C₂₄ thiolates have a surface coverage of from 0.8 to 6 square nanometers. As the surface area of inorganic particulate is readily determined by BET, microscopy or other well known techniques, the needed quantity of organic salt to create a passivating monolayer or any other desired surface coverage of the inorganic particulate is determined. As the density of organic salts is generally lower than that of the inorganic particulate, the net effect of organic salt surface derivatization is to reduce the net inorganic particulate density. Preferably, the unmodified inorganic particulate is fumed silica that has been surface silanized. More preferably, when the thixotrope is fumed silica, the surface area is between 20 and 500 meters squared per gram. Still more preferably, the surface treated fumed silica is present from 5 to 7 total weight percent of the formulation. Preferably, the organic salt modified organic particulate is tetra octyl ammonium modified bentonite clay. More preferably, modified bentonite clay has a greater than 90% of the bentonite particulate having a particle size of less than 1 micron. Still more preferably, the tetra alkyl ammonium bentonite modified bentonite is present from 3 to 10 total weight percent of the formulation.

Homogeneous dispersion of thixotropic particulate is achieved through dispersion in a solvent that in turn is mixed with a portion of the polymerizable monomer or the inorganic particulate is directly mixed into a portion of the polymerizable monomer. Homogenizing typically 5 to 50 weight percent of the polymerizable monomer of an inventive anaerobic adhesive composition with the thixotrope at 1000 to 2000 rpm optionally affords a master batch that speeds final adhesive compounding. Solvents suitable for thixotropic particle slurrying, if used, are required to be shelf life stable relative to the polymerizable monomer and peroxy polymerization initiator present in the composition. Suitable solvents illustratively include mineral oil, mineral spirits, castor oil, C₈-C₁₅ alkyl benzoates, C₈-C₂₄ alkanes and C₈-C₂₄ esters thereof, with branched alkyls used preferentially to linear normal analogs.

Alternatively, an organic thixotrope is present alone, or in combination with, an unmodified inorganic or organic salt modified particulate thixotrope. Organic thixotropes operative herein illustratively include hydrogenated castor waxes; hydrogenated castor oils; triglycerides such as glyceryl tri-12 hydroxy stearate. It is appreciated that the presence of an amide having 10 to 24 fatty acids carbon atom facilitates dispersion of triglycerides. Specific amide waxes operative herein include 12-hydroxystearic acid diamide of ethylene diamine, 12-hydroxystearic acid diglycol amide, N-stearyl ricinoleamide, and N-stearyl stearamide. Typically, an organic thixotrope is present from 3 to 36 total weight percent. Preferably, the organic thixotrope is a triglyceride. More preferably, an amide wax is present at about 0.25 to 0.5 total weight amount of triglyceride present. Polyamide waxes, exemplified by Disparlon 6200, 6100, and 6500 from King Industries of Norwalk, Conn. can also be used by themselves or in combination with other amide materials.

Examples of other organic thixotropes useful in this invention are ureaurethanes, believed to be exemplified by BYK-410 from BYK-Chemie of Wallingford, Conn., and polyester-amide compound, exemplified by Thixin R, GR and Thixotrol TSR from Rheox Inc., Highstown, N.J.

By way of a non-limiting theory, it is believed that inorganic particulate acts as a thixotrope through the formation of weak bonding forces between proximal particles. In the instance where an inorganic particle has a hydrogen-rich and/or hydroxyl-rich surface, hydrogen bonding causes the system viscosity to increase over time yet under high shear forces the loose structure of interacting inorganic particles is disrupted quickly with subsequent viscosity breakdown. Van der Waal bonding has also been identified as a source of thixotropic properties. Other inorganic particulate thixotropes such as graphitic carbons and clays tend to accumulate successive platelet layers due to electrostatic attraction with the formation of ionic double layers associated with platelet faces and edges. These platelet accumulations supported by electrostatic double layers are readily disrupted under high shear forces with a subsequent decrease in system viscosity. Based on the characteristics of a particular inorganic particulate, and the energetics of the non-covalent bonds formed between proximal particles, one skilled in the art can predict the relative quantities of various particles needed to satisfy the thixotropic viscosity ratios recited in the present invention.

It is noted that in some instances the anaerobic adhesive composition according to the present invention containing inorganic particulate has a higher strength and more uniform failure profile, as compared to the same base formulation lacking a thixotrope. By way of nonlimiting theory, it is believed that the inorganic particulate domains serve to deflect crack propagation through the adhesive composition and in the process increase crack propagation path length. Depending on the rate of crack propagation through an inventive composition, varying amounts of inorganic particulate fracture and/or pullout from the surrounding cured adhesive matrix is also observed. Both these phenomena increase the amount of energy necessary to propagate a crack through a cured inventive composition.

Polymerization inhibitors and metal ion chelating agents are conventional to the art for extending shelf life and preclude peroxy initiator degradation, respectively. Inhibitors and chelating agents, when present, are preferably added during initial anaerobic adhesive formulation. As trace metal ions are common in formulation constituents and may also be incorporated through contact with metallic vessels, chelating agents or a scavenging solvent serve to render the metal ions less reactive towards peroxy initiator and other formulation components.

Metal scavenging preferably occurs through admixture in a scavenging solvent which illustratively includes a non-polar aliphatic, aromatic, alcohol or the like which is not reactive towards the peroxy initiator. Toluene, isopropyl alcohol and mixtures thereof are specific examples of solvents operative to scavenge metal ions. Such solvents are typically present from 0.1 to about 2 total weight percent.

A chelating agent is alternatively operative herein and illustratively includes: ethylenediaminetetraacetic acid (EDTA), diethylenetriaminepentaacetic acid (DTPA), nitrilotriacetic acid (NTA), iminodiacetic acid (IDA), iminotriacetic acid (ITA), ethylenediamine (En), N,N′-diethylenediamine (Oen), diethylenetriamine (DTN), diethylenetetramine (Trien), triaminotriethylene amine, propylenediamine, salts of the aforementioned chelating agents, and combinations thereof. Chelating agents are typically present from about 0.1 to 5 total weight percent.

An inhibitor operative in the present invention includes any of the conventional inhibitors operative to stabilize anaerobic adhesive formulations and illustratively include hydroquinones, benzoquinones, naphthaquinones, phenanthraquinones, anthraquinones, and substituted compounds thereof. An inhibitor is typically present from 0.1 to 2 total weight percent.

According to the present invention, an anaerobic adhesive composition has a static viscosity of between 380,000 and 1,300,000 centipoise as measured at 0.5 revolutions per minute using a T-D spindle (Brookfield Engineering Laboratories, Middleborough, Mass.). An inventive thixotropic anaerobic composition exhibits a viscosity at 10.0 rpm with spindle T-D of between 30,000 and 120,000 centipoise prior to cure where the ratio of viscosities measured at spindle rotation rates of 0.5 and 10.0 rpm varies between 8.2:1 and 11:1.

It is appreciated that a chelating agent present to reduce the reactivity of transition metal ions present in the inventive adhesive composition affects the overall composition thixotropic ratio. In general, the chelating agent has modest effect on static viscosity while under higher shear forces; a general trend towards lower viscosity with higher chelating agent concentration is noted. However, as the basis for thixotropic properties in an inventive composition is not well understood, these trends should be considered only as general guidance with the possibility that in specific chelating agent concentrations, particular interparticle bonding states are formed that defy general trends.

A solvent or polar additive added to an inventive composition optionally is added to modify an inventive composition thixotropic ratio. A solvent is chosen to be non-reactive with the peroxide constituent and is typically present from 0 to 10 total weight percent. Preferably a solvent or polar additive is present from 0.1 to 5 total weight percent. Solvents operative herein illustratively include water, alcohols, aryls, and aliphatics. Specific solvents operative herein include water, glycerin, propylene glycol, and toluene. It is appreciated that several such solvents or polar additives also have metal scavenging properties and that the quantity of scavenging solvent is subsumed in the 0 to 10 total weight percent.

The following examples are provided to demonstrate typically compositions within the scope of the invention and methods for the preparation and use thereof. These examples are not intended to be limitations upon the invention as defined by the appended claims. Unless stated to the contrary, all ratios and percentages provided in the examples are on a total weight basis. A base polymerizable liquid anaerobic adhesive system is prepared by mixing the constituents described in Table 1 in the proportions indicated.

TABLE 1

| Ingredient | Weight Percentage |
|---|---|
| Polyglycol dimethacrylate | balance |
| (PEG average molecular weight = 200) | |
| Cumene hydroperoxide | 3.0 |
| Acetylphenylhydrazine | 0.4 |
| Hydroquinone | 100 parts per million |

This base anaerobic adhesive composition is then used for the preparation of thixotropic inventive compositions.

Examples 1-10 inclusive are prepared by adding amounts of fumed silica that has been surface treated to create a trimethyl silyl-rich hydrophobic surface. Additional amounts of the chelating agent EDTA alone, or in concert with a small amount of solvent, is added to yield compositions that contain the stated total weight percentage of these constituents as shown in Table 2. Table 2 also shows the viscosity measured in centipoise for spindle T-D rotating at the stated speeds of 0.5 and 10.0 rpm along with the resulting thixotropic ratio of viscosity measured at 0.5 and 10.0 rpm.

TABLE 2

| | | Spindle T-D, | | |
|---|---|---|---|---|
| | | Speed | Viscosity | Thixo |
| Example | Description | (rpm) | (cP) | Ratio |
| 1 | 6% hydrophobic fumed | 0.5 | 636,000 | 8.3 |
| | silica, 0.14% EDTA | 10.0 | 76,600 | |
| 2 | 7.5% hydrophobic fumed | 0.5 | 1,216,000 | 10.5 |
| | silica, 0.14% EDTA | 10.0 | 115,600 | |
| 3 | 7% hydrophobic fumed | 0.5 | 1,100,000 | 10.7 |
| | silica, 0.04% EDTA | 10.0 | 102,600 | |
| 4 | 7% hydrophobic fumed | 0.5 | 1,016,000 | 10.3 |
| | silica, 0.07% EDTA | 10.0 | 98,800 | |
| 5 | 7% hydrophobic fumed | 0.5 | 1,084,000 | 10.1 |
| | silica, 0.10% EDTA | 10.0 | 107,200 | |
| 6 | 7% hydrophobic fumed | 0.5 | 976,000 | 10.4 |
| | silica, 0.14% EDTA | 10.0 | 93,600 | |
| 7 | 6.5% hydrophobic fumed | 0.5 | 776,000 | 8.8 |
| | silica, 0.14% EDTA | 10.0 | 88,000 | |
| 8 | 6.5% hydrophobic fumed | 0.5 | 712,000 | 9.3 |
| | silica, 14% EDTA, 0.5% | 10.0 | 76,200 | |
| | distilled H₂O | | | |
| 9 | 6.5% hydrophobic fumed | 0.5 | 846,000 | 9.6 |
| | silica, 0.14% EDTA, 0.5% | 10.0 | 84,800 | |
| | glycerin | | | |
| 10 | 6.5% hydrophobic fumed | 0.5 | 776,000 | 9.1 |
| | silica, 0.14% EDTA, 0.5% | 10.0 | 85,200 | |
| | propylene glycol | | | |

The compositions of the base anaerobic adhesive of Examples 1-10 above are each in turn tested as a bolt sealant. The threaded portions of a series of standard one-half inch bolts are dipped into one of the above compositions. Each bolt is threaded into a complementary bore. After allowing 24 hours for anaerobic cure to occur, the torque required to initiate bolt movement and the average torque to complete a complete revolution of the bolt. The results of which are indicated that the exemplary compositions containing 7.5 total weight percent or more of fumed silica tended to be too gelatinous to flow into bolt threads resulting in initial release torques in the range of 100 to 150 inch pounds torque are noted with subsequent average disassembly torques of 20 to 80 inch pounds being observed. In contrast, exemplary compositions containing 6.5 or 6% hydrophobic fumed silica alone exhibit initial release torques and average disassembly torques consistent with a composition that flows into bolt threads. These lower percentage fumed silica containing compositions exhibited initial release torques of 125 to 350 inch pounds and average disassembly torques thereafter of 200 to 350 inch pounds.

### EXAMPLE 11

The base composition as detailed in Table 1 is mixed with carbon black and EDTA where the carbon black is present at 48 total weight percent and EDTA is present at 0.14 total weight percent. The resulting composition has viscosity and thixotropic ratio values similar to Example 3.

### EXAMPLE 12

The base composition as detailed in Table 1 is detailed with 3 total weight percent steralkonium-90 derivatized bentonite clay having a particle size of less than 1 micron sold under the trade name TIXOGEL VZ-V (Süd-Chemie, Louisville, Ky.) along with the addition of 1 total weight percent methanol and 0.05 total weight percent water, the methanol and water being added after the slow and complete addition of the bentonite. The resulting composition has viscosity and thixotropic ratio values similar to Example 7.

Patents and publications mentioned in the specification are indicative of the levels of those skilled in the art to which the invention pertains. These patents and publications are incorporated herein by reference to the same extent as if each individual patent or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An anaerobic adhesive composition comprising:
a polymerizable monomer curable upon exclusion of oxygen;
a peroxy polymerization initiator; and
a thixotrope selected from the group consisting of: inorganic particulate present from 3 to 50 total weight percent, and an organic compound present from 3 to 36 total weight percent where said composition has a thixotropic viscosity ratio in an uncured state of between 8.2:1 and 11:1 as measured at rotation rates of 0.5 and 10.0 revolutions per minute.

2. The composition of claim 1 wherein the composition has a viscosity measured at 0.5 revolutions per minute between 600,000 and 1,200,000 centipoise.

3. The composition of claim 1 wherein said composition has a viscosity measured at 10.0 revolutions per minute of between 60,000 and 140,000 centipoise.

4. The composition of claim 1 wherein the thixotropic ratio is between 8.8:1 and 10.1:1.

5. The composition of claim 1 wherein said ratio is between 10:1 and 11:1 and viscosity at 0.5 revolutions per minute is between 600,000 and 1,000,000 centipoise.

6. The composition of claim 1 wherein said thixotrope is said inorganic particulate.

7. The composition of claim 1 further comprising an organic salt ion associated with said inorganic particulate.

8. The composition of claim 7 wherein said organic salt ion is selected from the group consisting of: a quaternary C₁-C₂₄ ammonium, a C₂-C₂₄ thiolate, and a C₈-C₂₄ alkyl alkonium.

9. The composition of claim 7 wherein said organic salt ion coats said inorganic particulate.

10. The composition of claim 1 wherein said inorganic particulate is selected from the group consisting of: silica, fumed silica, diatomaceous earth, bentonite clay, alumina, titania, metal oxide nanocrystals, metal sulfide nanocrystals, inorganic nanotubes, high surface area graphite, turbostratic carbon, and boric acid.

11. The composition of claim 10 wherein said fumed silica has a hydrophobic surface and is present from 5 to 7 total weight percent of said composition.

12. The composition of claim 6 wherein said monomer comprises an acrylate ester.

13. The composition of claim 6 wherein said monomer comprises a vinyl ether.

14. The composition of claim 1 wherein said organic compound is selected from the group consisting of: hydrogenated castor oils, hydrogenated castor waxes, and triglycerides.

15. The composition of claim 1 further comprising a metal scavenger selected from the group consisting of: a chelating agent and a metal scavenging solvent.

16. The composition of claim 1 further comprising a solvent or polar additive.

17. A process for forming an anaerobic adhesive bond comprising:
applying to a fastener an anaerobic adhesive composition comprising: a polymerizable acrylate ester or vinyl ether, a peroxy polymerization initiator, and a thixotrope, said composition as applied is a gel having a thixotropic viscosity ratio of between 8.2:1 and 11:1 for spindle rotation rates of 0.5 and 10.0 revolutions per minute;
tightening said fastener against a substrate induces viscosity breakdown; and
allowing sufficient time for said composition to flow under forces associated with tightening and cure.

18. The process of claim 17 wherein said fastener is a bolt.

19. The process of claim 17 wherein said thixotrope is inorganic particulate.

20. The process of claim 19 further comprising coating said inorganic particulate with an organic salt prior to applying said composition to said fastener.

21. The process of claim 17 wherein the viscosity at 0.5 revolutions per minute between 600,000 and 1,200,000 centipoise.

22. A fastener secured to a substrate with the composition of claim 1.
